(19) United States
(12) Patent Application Publication
(10) Pub. No.: US 2004/0028765 A1
(43) Pub. Date: Feb. 12, 2004

(54) Apparatus for home-made tablet-making

(75) Inventors: Mordechai Kerzner, Kfar Adumim (IL); Eli Pinthus, Maale Adumim (IL); Chanoch Kotev, D.N. Mizrach Benyamim (IL)

Correspondence Address: BROWDY AND NEIMARK, P.L.L.C., 624 Ninth Street, N.W., Washington, DC, 20001, US

(73) Assignee: TIY Inc., Melville, NY (US)

(21) Appl. No.: 10/216,666

(22) Filed: Aug. 12, 2002

(51) Int. Cl. B30B 11/04

(52) U.S. Cl. 425/167; 425/352; 425/354

(57) ABSTRACT

A tablet-making apparatus comprising die supports and guide supports fixed upon a base, plunger guides supported by the guide supports, a die having an opening through which powder may be charged, two plunger rods with opposing faces, the rods being horizontally disposed and reciprocally received within the die, and a means for activating the reciprocal movement of the plungers whereby, a tablet may be formed within the die and between the opposing plunger rod faces and then moved to a position to be gravitationally discharged.

### FIELD OF THE INVENTION

This invention relates to a tablet-making apparatus particularly an apparatus designed for making tablets at home.

### BACKGROUND OF THE INVENTION

There is a significant demand for nutritional supplements, the supply of which is presently, typically, supplied by companies producing vitamins and health supplements. Despite a large variety of choices for nutritional supplements, the consumer often prefers to customize of control the mix of the supplements that he or she consumes, or at least likes to have the option thereof.

Furthermore, it may be appropriate for a different mixture (composition) or dose of supplement especially as a result of the different characteristics of the consumer, e.g. based on age, sex, size, activity level, individual body chemistry, lifestyle, medical limitations, drug contraindications, diet and eating habits, etc. For example, an individual talking a diuretic for high blood pressure may desire a high dose of potassium to replace lost electrolytes. In another example, women who as a group often have lower than recommended iron and/or calcium in their diets may desire to increase the dosage of these constituents in their diets via supplements. Similarly, vegetarians may desire to particularly supplement their diets with proteins and/or vitamins, for example B12, etc.

Understood from die above examples, the individuals of a family may have significantly different requirements for their nutritional supplements. Thus, the opportunity to conveniently customize, at home, die composition and dose of such supplements, additionally, die ability to produce a desired number of supplement tablets, is advantageous. In this manner, there would not be a need to potentially have large quantities of nutritional supplement bottles.

The art of tabletting is known in the art, often utilizing a rotary tablet press. Typically, tabletting machines or tablet presses comprise a die into which a powder composition is loaded, or charged, and where the tablet is formed. Upper and lower punches then compress the powder in the die to form a tablet.

Tablet press mechanisms also typically include a structure for removing, (ejecting/discharging) the formed tablet from the punches and dies. Normally, tabletting presses comprise tablet removal mechanisms that include a cam system that causes the lower punch to lift the formed tablet to the surface of a press table after compression. A removal mechanism such as a blade, stripper member, or the like is disposed slightly above the press table that scrapes the tablet from the press table to a discharge chute. Alternatively the die way also be turned to facilitate tablet removal, or a manual or other means may be employed.

However, the prior art designs do not include tabletting apparatus that are convenient and economic for low-volume production of tablets applicable for home use, and frequent changes in tablet composition and/or dosage. Furthermore, prior art designs typically require a component such as a blade to strip off or remove the formed tablet from the apparatus.

### SUMMARY OF THE INVENTION

Accordingly, it is an object of the present invention to provide a simple, economic, user friendly, small-scale tablet-making apparatus amenable for home use. The simplicity of the apparatus is aided in that the discharge or ejection of the formed tablet from the apparatus is performed by gravity and does not require any additional components or steps. An associated feature facilitating the gravitational ejection of the formed tablet is that the apparatus comprises plungers that move, at least essentially, in a horizontal motion.

It is a further object of the present invention to provide a tablet-making apparatus that is designed to facilitate customization of the composition, dosage (tablet size) and number of tablets in a batch.

It is a further object of the present invention to provide such a tabletting apparatus that comprises a means whereby the apparatus can be programmed to produce a predetermined composition, dosage (tablet size), and number of tablets in a batch.

In addition to home use, the apparatus could be used in venues such as health clubs or health stores for example, where individual patrons could be supplied with customized tablets for nutritional supplements and the like.

The present invention thus relates to a tablet-making apparatus that is designed for easy operation and the economic production of tablets from powders, each batch of tablets having the option of a customized composition, dosage and number. The present invention is particularly applicable to the small-scale production of tablets in the home.

Here and in the following specification and claims the term “powder” is used in its broadest aspect and denotes any powder or mixture of powders or powder composition that is amenable to being formed into a tablet.

In accordance with the present invention, there is provided a tablet-making apparatus comprising, a base; die supports fixed upon said base; guide supports fixed upon said base; plunger guides supported by said guide supports; a die, with an opening through which a powder may be charged therein, said die being supported by said die supports; a first plunger and a second plunger, said plungers being guided by said plunger guides, said first plunger having a first rod with a first face and said second plunger having a second rod with a second face opposing said first face, said rods being horizontally disposed and reciprocally received within said die; and a means for activating the reciprocal movement of said plungers; whereby, a tablet may be formed from a powder in the die by a force exerted on said powder by a motion of said first face toward said second face and wherein the formed tablet may be moved to a position to be gravitationally discharged.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1A is a side view of a tablet-making apparatus according to the present invention;

FIG. 1B is a view of a tablet-making apparatus according to FIG. 1A showing options for automatic operation of the invention;

FIGS. 2A, 2B and 2C are side views of the die and plungers of FIG. 1 illustrating three stages of tablet production.

### DETAILED DESCRIPTION OF THE INVENTION

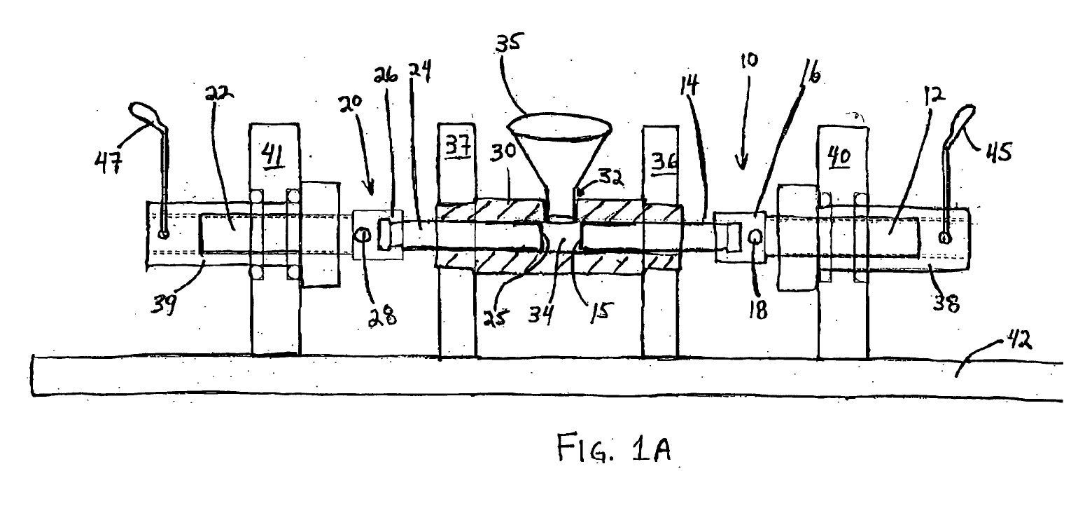

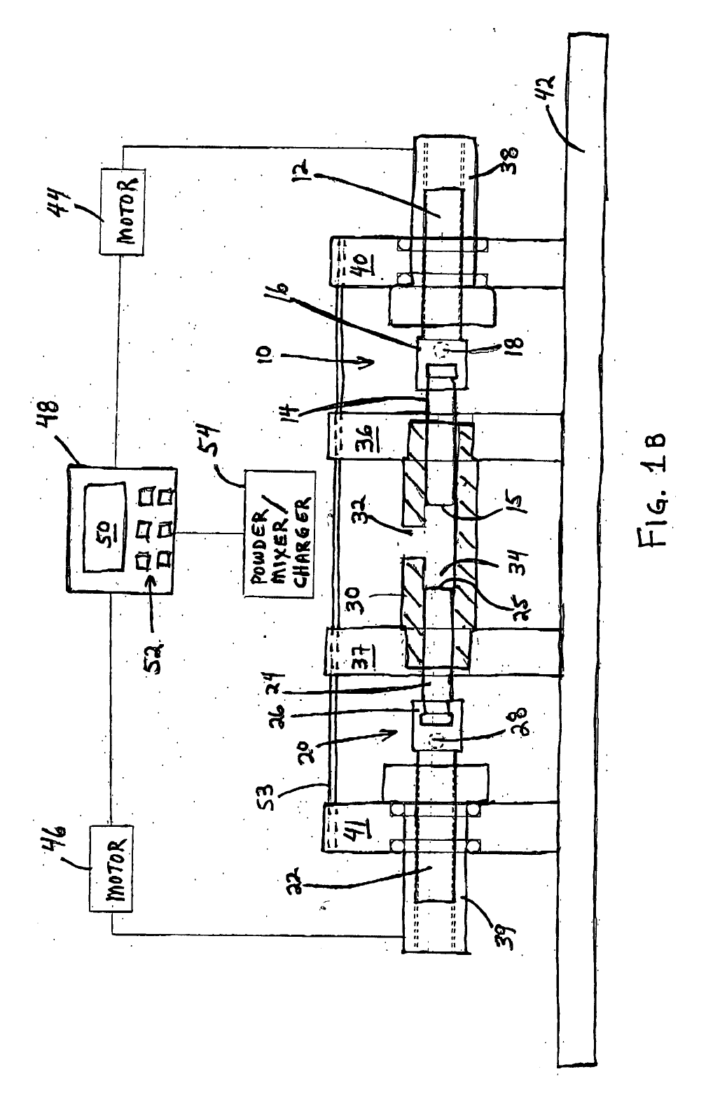

Referring first to FIG. 1A, there is shown a tablet-making apparatus according to the present invention comprising a first plunger 10 and a second plunger 20. The first plunger comprises a first ram 12 and a first rod 14 connected by a first linkage 16 held in place by a first pin 18. The second plunger 20 comprises a second ram 22 and a second rod 24 connected by a second linkage 26 held in place by a second pin 28.

Although the plungers 10 and 20 are shown as each composed of four separate components, it is understood that the plungers 10 and 20 could alternatively be formed by integrating the components in any variety of combinations.

The plungers 10 and 20 are reciprocally received horizontally in a cylindrical die 30 (illustrated with hatched lines for contrast) at both ends of the die. The die 30 also has an upwardly facing opening 32 for receiving powder to be formed into a tablet, within a die chamber 34. The powder may be charged with the aid of a funnel 35.

At the time when powder to be formed into a tablet is charged into the chamber 34, the size of the chamber is defined by the inner diameter of the die 30, and also by the position of the rods 14 and 24. When the powder is charged, the positioning of the rods 14 and 24 should be spread apart to an extent so as to ensure the proper space for the powder to be received. Thus, since powder has a tendency to pile, the upper limit to the tablet size (dosage) is mainly a function of the inner diameter of die 30 and possibly related to the size of the opening 32.

The die 30 is held in place by die supports 36 and 37 while the plungers 10 and 20 are held in place by plunger guides 38 and 39, respectively, which are supported by guide supports 40 and 41, respectively. The die supports 36 and 37, and plunger supports 38 and 39 are constructed so that the plungers 10 and 20 are in a straight line. The aligned first and second rods 14 and 24 have respective opposing faces—first face 15 and second face 25. Supports 36, 37, 40 and 41 are held in place by, and are attached to, a base 42.

The movement of the plungers 10 and 20 may be activated by handles 45 and 47, respectively.

FIG. 1B shows an apparatus similar to that illustrated in FIG. 1A, however there are provided motors 44 and 46 for activating plungers 10 and 20 and a controlling means 48 having a display 50 and function keys 52 for allowing the user to program the apparatus.

Additionally, there may be provided an upper stabilizing rod 53, which may be necessary depending on the forces used during the tablet forming procedure. For added strength more than one rod 53 may be used, for example in the upper corners of the supports 36, 37, 40 and 41.

The controlling means 48 could be used to program options such as tablet composition, tablet dosage (size/weight) and number of tablets produced in a batch by actuating an automatic powder mixing and charging means 54 which would affect the allotment of individual powder constituents and load the resultant powder mixture into the chamber 34. Thus, the quantity of each constituent powder composing the powder mixture may be automatically portioned and the number of tablets to be produced may be programmed whereby the apparatus may then operate unsupervised.

Optionally, the force that the plungers 10 and 20 exert on the powder can also be controlled, thereby optimizing the structural integrity of the tablet.

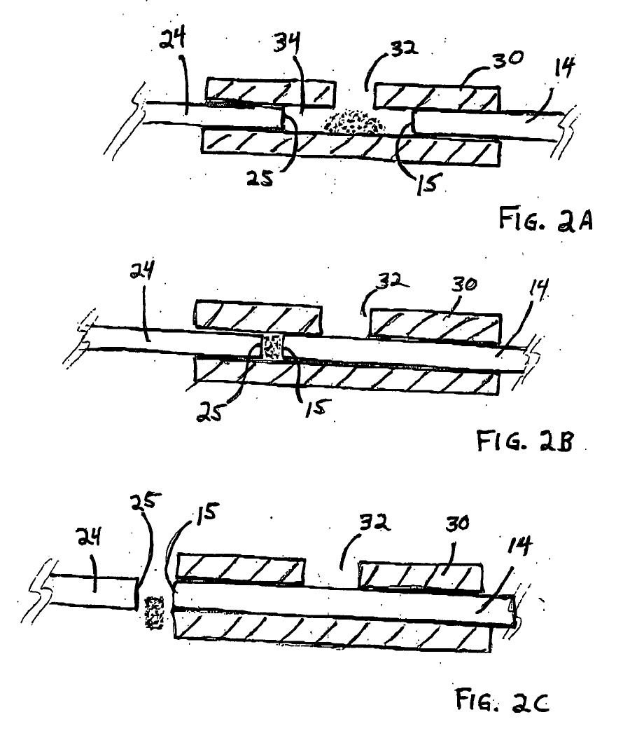

Three stages of the tablet-making operation are illustrated in FIGS. 2A, 2B and 2C. For clarity, only the rods 14 and 24 and the die 30 are shown.

In the first stage, seen in. FIG. 2A, a powder to be made into a tablet has bee added to the chamber 34. The first face 15 and second face 25 of the respective rods 14 and 24 are relatively quite separate from each other to allow ample volume for the powder to be charged into the chamber 34.

In the second stage, seen in FIG. 2B, rod 14 has been moved toward rod 24 (“forward”—from right to left in FIG. 2A) in order to compress the powder into a tablet within the die 30 and between faces 15 and 25. Rod 24 remains stationary in this stage to provide a counter force and thus the tablet is formed.

To eject the formed tablet, rod 24 is moved away from rod 14 (“backward”—from right to left) and rod 14 follows rod 24, either immediately, or after a short hold. If rod 14 follows rod 24 immediately, rod 24 must move “backward” at a rate at least as rapid as the rate at which rod 14 moves forward.

In a slight variation, the forward movement of rod 14, pressing on the newly formed tablet, may be used to urge the backward motion of rod 24 and the mechanism that holds rod 14 in place to provide a counter force during the first stage is released.

Finally, the formed tablet is discharged from the apparatus in a third stage as seen in FIG. 2C. Here, the rod 14 has been moved forward (to the left) to the point where its face 15 has arrived to a position just beyond the die 30. Rod 24 has been moved to a position where its face 25 is separated from face 15 of rod 14 by a distance at least a bit greater than the width of the tablet and thus the tablet is free to fall under the power of gravity. A container (not shown) may be placed underneath the edge of the die 30 to collect the tablet.

Alternatively, the die 30 may comprise a discharge opening (not shown) through which the formed tablet may be discharged.

As a result of the horizontal disposition of the plungers 10 and 20 and their respective rods 14 and 24, no auxiliary components are necessary to discharge the formed tablet.

In the second stage, rod 24 may be held in place by the urging of the motor 46, a manual handle (not shown) or a locking means (not shown).

After the rods 14 and 24 are returned to their position as shown in FIG. 2A, the process may be repeated. Thereby, a batch of tablets may be produced. When the production of one batch of tablets is completed, the production of another batch, possibly with different characteristics (i.e. a different dosage—tablet size/weight—and/or a different composition or a different number of tablets) may commence.

It may be appropriate to clean the apparatus between the production of different batches of tablets, especially when a subsequent batch comprises a different powder mixture than the previous. For cleaning, the plungers 10 and 20 may be moved to a position to provide access to them and the interior of the die 30, by means of the handles 45 and 47 or the motors 44 and 46.

It should be noted that various components of the tablet-making apparatus described above, as well as variations thereof are provided merely by way of illustration and are by no means exclusive.

For example, the tablet-making apparatus could be designed to allow the die to be easily removed and changed-out to allow for the production of a number of different sized and/or shaped tablets, for example to produce star-shaped tablets that may be pleasing to children. A set of dies having various cross-sectional sizes could be convenient in the case of greatly varying tablet sizes.

In the case of different cross-sectional shapes, the die may be circular as in the case of the cylindrical die described above; or it may be square, rectangular, elliptical, triangular, star-shaped, etc. Naturally the rods would then be shaped accordingly.

In another example, the apparatus could further comprise a means to heat the powder when it is within the die, for example with an electrical heating coil or jacket. The die should be thermally insulated to retain the heat in the die and provide safety to the user. In such a case where a heating means is provided, the controlling means could further comprise a program for controlling the heating of the die and/or plunger rods. The option to beat the powder may prove beneficial to the tablet forming.

It will be appreciated that the above descriptions are intended to serve as examples, and that many other embodiments are possible within the spirit and scope of the present invention.

1. A tablet-making apparatus comprising,
a base;
die supports fixed upon said base;
guide supports fixed upon said base;
plunger guides supported by said guide supports;
a die, with an opening through which a powder may be charged therein, said die being supported by said die supports;
a first plunger and a second plunger, said plungers being guided by said plunger guides, said first plunger having a first rod with a first face and said second plunger having a second rod with a second face opposing said first face, said rods being horizontally disposed and reciprocally received within said die; and
a means for activating the reciprocal movement of said plungers;
whereby,
a tablet may be formed from a powder in the die by a force exerted on said powder by a motion of said fist face toward said second face and wherein the formed tablet may be moved to a position to be gravitationally discharged.

2. A tablet-making apparatus according to claim 1, wherein the apparatus further comprises a means for changing the powder into a chamber of the die.

3. A tablet-making apparatus according to claim 1, wherein the means for activating the movement of the plungers employs handles.

4. A tablet-making apparatus according to claim 1, wherein the means for activating the movement of the plungers employs motors.

5. A tablet-making apparatus according to claim 1, wherein the apparatus further includes a programming means to control the tablet making.

6. A tablet-making apparatus according to claim 5, wherein the programming means activates the movement of the plungers.

7. A tablet-making apparatus according to claim 5, wherein the programming means may further control the composition of the powder to be formed into a tablet.

8. A tablet-making apparatus according to claim 5, wherein the programming means controls the dosage (size/weight) of the powder to be formed into a tablet.

9. A tablet-making apparatus according to claim 5, wherein the programming means controls the number of tablets in a batch.

10. A tablet-making apparatus according to claim 5, wherein the programming means controls the plunger force on the powder to be formed into a tablet.

11. A tablet-making apparatus according to claim 1, wherein the die is removable and can be changed-out.

12. A tablet-making apparatus according to claim 1, wherein the die has an inner cross-sectional shape chosen from one of the following group: circular, square, rectangular, elliptical, triangular, star-shaped.

13. A tablet-making apparatus according to claim 1, wherein the apparatus further comprises a means to beat the powder to be formed into a tablet.

14. A tablet-making apparatus according to claim 1, wherein the apparatus further comprises one or more stabilizing rods for strengthening the apparatus.
